(19) United States
(12) Patent Application Publication
(10) Pub. No.: US 2007/0012407 A1
(43) Pub. Date: Jan. 18, 2007

(54) Venetian Blind Having Dual-Drive Mechanism

(75) Inventors: Ming Nien, Taichung (TW); Song-He Liu, Taichung (TW); Yu-Che Wen, Taichung (TW)

Correspondence Address: SHELDON MAK ROSE & ANDERSON PC, 225 SOUTH LAKE AVENUE, 9TH FLOOR, PASADENA, CA, 91101, US

(73) Assignee: Marc Karish, Pasadena, CA (US)

(21) Appl. No.: 11/533,342

(22) Filed: Sep. 19, 2006

Related U.S. Application Data
(62) Division of application No. 10/701,042, filed on Oct. 30, 2003.
Application No. 10/701,042 is a continuation-in-part of application No. 10/143,330, filed on May 14, 2002, now Pat. No. 6,655,441.
Application No. 10/701,042 is a continuation-in-part of application No. 10/065,936, filed on Dec. 2, 2002, now abandoned.

(30) Foreign Application Priority Data
Oct. 11, 2002 (TW) 911202679
Oct. 11, 2002 (TW) 91123868

(51) Int. Cl. E06B 9/30

(52) U.S. Cl. 160/170

(57) ABSTRACT

A window blind includes a transmission mechanism for lifting and lowering and/or tilting the slats of a Venetian blind. The mechanism includes a manually operated or motorized driving unit, and at least one cord roll-up unit. In the manually operated configuration, a single independent operating device is connectable to one or more driving force inputs of the mechanism. Also disclosed is a method for controlling a blind.

### CROSS REFERENCE TO RELATED APPLICATIONS

This application is a divisional application of U.S. application Ser. No. 10/701,042, filed on Oct. 30, 2003, which claims the benefit of Taiwan applications Ser. Nos. 91123868 and 911202679, filed Oct. 11, 2002, and which is a Continuation-in-Part of U.S. application Ser. Nos. 10/143,330, now issued as U.S. Pat. No. 6,655,441, and U.S. Ser. No. 10/065,936, filed on Dec. 2, 2002 and May 14, 2002, respectively, all of these applications being hereby incorporated herein by reference.

### BACKGROUND

The present invention relates to Venetian blinds and, more specifically, transmission mechanisms and controls for manual and motor-driven blinds.

A variety of blinds including Venetian blinds, roller blinds, pleated blinds, honeycomb shades, accordion-like shades, Roman blinds, vertical blinds, curtains, and etc. are commercially available for use with a window to regulate the light, air, etc. A regular Venetian blind comprises headrail, a bottom rail, a plurality of slats arranged in parallel between the headrail and the bottom rail, a spacing adjustment or height control mechanism for controlling lifting and positioning of the bottom rail to change the extending area of the blind, a frequency modulation or phase control mechanism for controlling the tilting angle of the slats to regulate the light. The height control mechanism typically includes an endless lift cord suspended from the headrail at one lateral side for pulling by hand to lift/lower the bottom rail. The phase control mechanism comprises a phase member disposed at one lateral side of the blind for permitting rotation by the user to regulate the tilting angle of the slats. When adjusting the elevation of the bottom rail, the user must approach the blind and pull the lift cord by hand with much effort. Further, because the lift cord is not kept out of reach of children, children may pull the lift cord for fun. In case the lift cord is hung on a child's head, a fatal accident may occur. In order to eliminate this problem, blinds without exposed lift cords are disclosed. These blinds commonly use spring means and the gravity weight of the blind body to keep the blind body at the adjusted elevational position. However these blinds are not durable in use because the provided spring means wears quickly with use. U.S. Pat. No. 6,044,889 to Liu teaches the use of the tension of two cord members to hold the bottom rail of a Venetian blind at the adjusted elevation. However, the cord members are likely to become loosened after a long use. Further, the presence of the cord members destroys the sense of beauty of the blind. U.S. Pat. No. 5,103,888 to Nakamura discloses a blind slats lifting device that includes a pair of lifting cords that are wound onto respective winding drums that are driven by means of a loop of operation cord. Motor-driven blinds, which keep lift cords from sight are also known. According to one design, a motor is mounted in the headrail or bottom rail, and controlled by a remote controller to roll up or let off the lift cord. The motor is used to control lifting of the lift cord only. When adjusting the tilting angle of the slats, the user must approach the blind and touch-control a tilting control unit. This operation manner is still not convenient.

Electrically controlled blinds can be made easy to operate, and they can have improved appearance in that they do not require exposed lift cords or tilt rods, and the absence of an exposed lift cord is a safety feature. However, electrically controlled blinds are typically expensive to provide, each unit having at least one motor, a power supply device, and a control circuit. Also, the power supply device requires a battery or an external source of power, which in turn normally requires a power cord and a suitable power socket. Because of the problems associated with providing external power, typical devices of the prior art use battery power. However, because the battery of the power supply device of an electrically controlled blind is normally installed in the headrail, it is inconvenient to replace the battery when battery power low.

Thus there is a need for a blind control system and method that has no cord member exposed to the outside of the blind body, that does not require any exposed lift cord or tilt rod means, that enables the user to conveniently regulate the blind either manually or electrically, that is inexpensive to provide, and that otherwise avoids the disadvantages of the prior art.

### SUMMARY

The present invention meets this need by providing a Venetian blind having a single driver for adjusting both the position and orientation of blinds. In one aspect of the invention, the blind includes a headrail, a bottom rail, a set of slats supported between the headrail and the bottom rail, and a blind control system that includes a spacing adjustment set having a support, a spacing cord connected to at least one of the slats and adapted to decrease or increase a spacing between pairs of the slats, and a spacing adjustment wheel rotatably engaged to the support to roll up or let off the spacing cord; an angle adjustment set having an angle cord adapted to tilt the slats, an angle adjustment member rotatably supported relative to the support and adapted to roll up or let off the angle cord; and a drive mechanism for selectively driving the spacing adjustment wheel and the angle adjustment member to adjust both the spacing and tilt of the slats. In one preferred configuration, the drive mechanism includes an operating device coupled to the spacing adjustment wheel; a friction coupling between the spacing adjustment wheel and the angle adjustment member; and a stop device coupled between the angle adjustment member and the support to limit rotation of the angle adjustment member to a predetermined angle. In this configuration, the angle adjustment member is rotated by the spacing adjustment wheel as limited by the stop device upon rotary motion of the spacing adjustment wheel, thereby permitting adjustment of both the height and tilt of the blinds by driving the spacing adjustment wheel directly and the angle adjustment member indirectly.

The stop device can include a shoulder projecting at one side of the support, and a protruding block projecting from the angle adjustment member and adapted to act against the shoulder of the support. The friction coupling can include a biasing device which can be a coiled spring mounted between the support and the angle adjustment member and forcing the angle adjustment member against the spacing adjustment wheel to produce frictional contact therebetween.

Preferably the spacing adjustment wheel has a conical end portion disposed in the periphery thereof at one end for guiding winding of the spacing cord round the spacing adjustment wheel.

The drive mechanism can include an operating device and a transmission shaft coupled between the spacing adjustment wheel and the operating device. The drive mechanism can further include a worm and worm gear meshed therewith coupled between the operating device and the transmission shaft. Also, or in the alternative, the drive mechanism can include a driving force input member coupled to the transmission shaft, with the operating device having an operating portion at one end and an actuating portion at an opposite end for selectively rotating the driving force input member, the actuating portion having a coupling tip removably connectable to the driving force input member for rotating the transmission shaft. The operating device can include a hand crank.

The drive mechanism can include a reversible motor, a transmission shaft coupled between the reversible motor and the spacing adjustment wheel and driven by the reversible motor to rotate the spacing adjustment wheel, and a control circuit for operating the reversible motor in response to operator input. The transmission shaft can have a non-circular cross section fitted into a non-circular axial center through hole of the spacing adjustment wheel. The control circuit can include a remote controller having a signal transmitter adapted to transmit control signals, and a signal receiver adapted to receive control signals from the signal transmitter and to control operation of the reversible motor in response to the received control signal. Preferably the Venetian blind also includes a detector adapted to cut off power supply from the reversible motor when the slats of the Venetian blind are fully lifted or lowered. The detector can include a fixedly supported locating block, a wheel supported in the locating block and coupled to the drive mechanism for rotation and axial movement upon operation of the reversible motor, and two limit switches disposed at two sides in axial displacement path of the wheel of the detector and electrically connected to the driving unit and adapted to cut off power supply from the motor when touched by the wheel of the detector. The limit switches can be respectively disposed in positions corresponding to the fully lifted and lowered positions of the slats.

The motor can be mounted in an operating device, that is removably connectable for driving the transmission shaft. The drive mechanism can further include a meshed worm and worm gear coupled between the motor and the transmission shaft.

In an alternative configuration, the drive mechanism includes a linking mechanism mounted in the headrail and having a first driving force input unit rotatable by an external rotary driving force, including a driving force receiving portion for receiving an external rotary driving force, and a first driving force output unit coupled to the spacing adjustment wheel; a second driving force input unit rotatable by the external rotary driving force and having a driving force receiving portion adapted to receive the external rotary driving force, and a second driving force output unit coupled to the angle adjustment member; and an operating device selectively connectable to the first and second driving force input units for operation to rotate the driving force input units. The operating device can have an operating portion at one end for operation by hand and an actuating portion at an opposite end for selectively rotating the first and second driving force input units, the actuating portion having a coupling tip connectable to the driving force receiving portion of the selected driving force input unit. The operating device can include a hand crank or alternatively, a casing having the operating portion at one end, an actuating portion with a coupling tip connectable to the driving force receiving portion of the selected driving force input unit, a motor mounted within the casing and coupled to rotate the coupling tip, means for receiving a battery in the casing, and manually operable controls for selectively powering the motor from a battery.

### DRAWINGS

These and other features, aspects, and advantages of the present invention will become better understood with reference to the following description, appended claims, and accompanying drawings, where:

FIG. 1 is a perspective view of a Venetian blind according to the present invention, showing a friction transmission mechanism and a limit detector installed therein;

FIG. 2 is an exploded view of a cord roll-up unit of the friction transmission of FIG. 1;

FIG. 3 is an elevational assembly view of the cord roll-up unit shown in FIG. 2;

FIG. 4 is a sectional view of the cord roll-up unit shown in FIG. 3;

FIGS. 5-7 are axial views showing continuous action of an angle adjustment member of the friction transmission during spacing and angle adjustments of the blinds of FIG. 1;

FIGS. 8 and 9 are schematic drawings showing lift cord rolling up action of the cord roll-up unit of FIG. 2;

FIG. 10 is a perspective view in an enlarged scale of the detector shown in FIG.1;

FIGS. 11-13 are schematic drawings showing the action of the detector according to the present invention;

FIG. 14 is an elevational view showing an alternative configuration of the blinds of FIG. 1, including a blind control system thereof;

FIG. 15 is a fragmentary sectional elevational view of a portion of the blind control system of FIG. 14;

FIG. 16 is a side view of an operating device portion of the blind control system of FIG. 14;

FIG. 17 is a side view showing an alternative configuration of the operating device portion of FIG. 16;

FIG. 18 is a side view showing another alternative configuration of the operating device of FIG. 16; and

FIG. 19 is a pictorial diagram showing the Venetian blind having the friction transmission of FIGS. 1-13 including features of the blind control system of FIGS. 14-18.

### DESCRIPTION

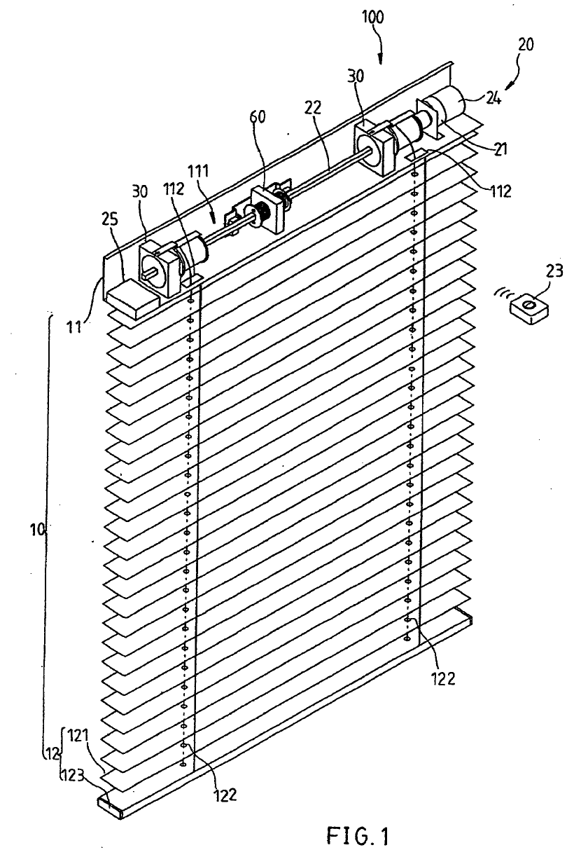

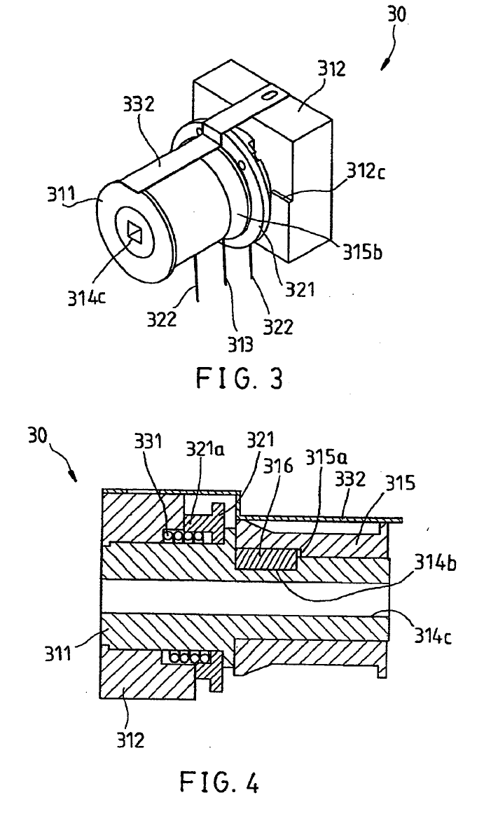

Referring to FIGS. 1-4, the present invention provides a Venetian blind 10 having a novel transmission mechanism 100. An exemplary configuration of the Venetian blind 10, shown in FIG. 1, includes a headrail 11 and a slat set 12. The headrail 11 is mountable to the top side of the window, and is formed to provide an inside holding chamber 111, and two through holes 112 bilaterally disposed at a bottom side in communication with the holding chamber 111. The slat set 12 includes a plurality of slats 121 and a bottom rail 123. Each slat 121 has two wire holes 122 aligned with the through holes 112 of the headrail 11. Because these features of the Venetian blind 10 are of the known art, no further detailed structural description is necessary. The friction transmission mechanism 100 includes a driving unit 20 and two cord roll-up units 30.

As shown in FIG. 1, one preferred form of the driving unit 20 includes a reversible motor 21, a transmission shaft 22, a signal transmitter 23, a signal receiver 24, and a battery 25. The motor 21 is mounted inside the holding chamber 111 of the headrail 11. The transmission shaft 22 is a non-circular rod member, having one end coupled to the motor 21 for rotation by the motor 21. The signal transmitter 23 can be a remote controller or wired controller for providing control signal to the signal receiver 24. According to the present preferred embodiment, the signal transmitter 23 is a remote controller. The signal receiver 24 is electrically connected to the motor 21, and adapted to control the operation of the motor 21 subject to the nature of the control signal received from the signal transmitter 23. The battery 25 can be storage battery, dry battery, planar battery, cylindrical battery, or mercury battery mounted inside of the holding chamber 111 and electrically connected to the motor 21 to provide the motor 21 with the necessary working power. Alternatively, or in combination, an external source of power can be provided.

The cord roll-up units 30 are respectively mounted inside the holding chamber 111 of the headrail 11 in alignment with the through holes 112, each including a spacing adjustment set 31, an angle adjustment set 32, and a linkage 33, the set 31 being sometimes referred to as an amplitude modulation set, the set 32 being sometimes referred to as a frequency modulation set.

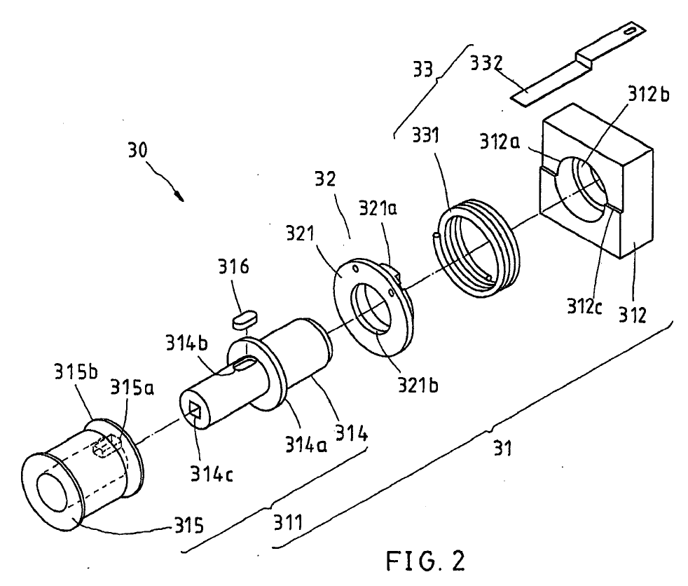

Referring to FIGS. 2-4 again, the spacing adjustment set 31 includes a spacing adjustment wheel 311, a support 312, and a spacing cord 313. The spacing adjustment wheel 311 is comprised of a cylindrical wheel body 314, a bobbin 315, and a coupling member 316. The cylindrical wheel body 314 comprises a stop flange 314a extended around the periphery on the middle, a recessed hole 314b disposed in the periphery adjacent the stop flange 314a for accommodating the coupling member 316, and an axially extended center through hole 314c for accommodating the transmission shaft 22 of the driving unit 20. The center through hole 314c has a cross section fitting the cross section of the transmission shaft 22. The bobbin 315 is sleeved onto the cylindrical wheel body 314 and stopped at one side of the stop flange 314a, having a keyway 315a in the inside wall thereof for receiving the coupling member 316 and a conical end portion 315b peripherally disposed at one end. The support 312 is fixedly mounted inside the holding chamber 111 of the headrail 11, having a stepped center through hole formed of a through hole 312b and a recessed hole 312a, and two shoulders 312c bilaterally disposed outside the recessed hole 312a. The inner diameter of the through hole 312b is smaller than the recessed hole 312a. The cylindrical wheel body 314 is rotatable within the recessed hole 312a, being rotatably supported within the through hole 312b. As illustrated in FIGS. 1, 3, and 9, the spacing cord 313 has one end fixedly connected to the bobbin 315 of the spacing adjustment wheel 311, and the other end wound round the bobbin 315 and then inserted through one through hole 112 of the headrail 11 and one wire hole 122 of each slat 12 and then fixedly connected to the bottom rail 123.

The angle adjustment set 32 includes an angle adjustment wheel 321, and an angle cord 322. The angle adjustment wheel 321 comprises a protruding block 321a disposed at one side, and an axially extended circular hole 321b. By means of the circular hole 321b, the angle adjustment wheel 321 is coupled to the cylindrical wheel body 314 of the spacing adjustment wheel 311 and stopped at one side of the stop flange 314a, keeping the protruding block 321a suspended or angularly confined between the shoulders 312c. The angle cord 322 has one end fixedly connected to the angle adjustment wheel 321, and the other end inserted through one through hole 112 of the headrail 11 and fixedly connected to each slat 121 and the bottom rail 123.

The linkage 33 includes a spring member 331, and a limiter 332. According to the present preferred embodiment, the spring member 331 is a coiled spring mounted in the recessed hole 312a of the support 312 and stopped between the angle adjustment wheel 321 and the connection area or shoulder between the recessed hole 312a and the through hole 312b. The spring 331 forces the angle adjustment wheel 321 against the stop flange 314a of the cylindrical wheel body 314. The limiter 332, fixedly mounted on the support 312, can be formed for preventing the angle adjustment wheel 321 from falling out of the spacing adjustment wheel 311. Also, the limiter 332 serves to keep the cords from falling off of the wheels in the event that the cords are loosened during installation, cleaning, or other such handling of the blinds.

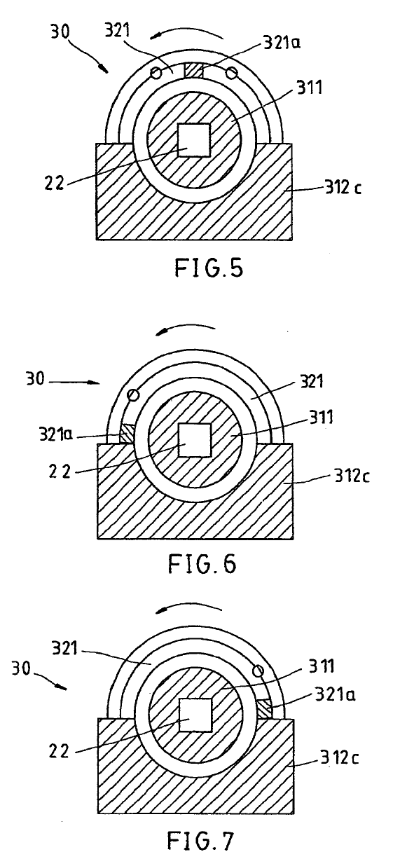

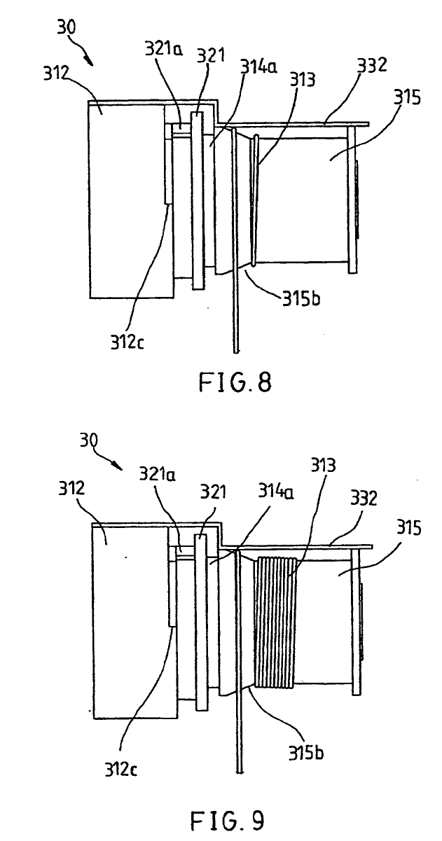

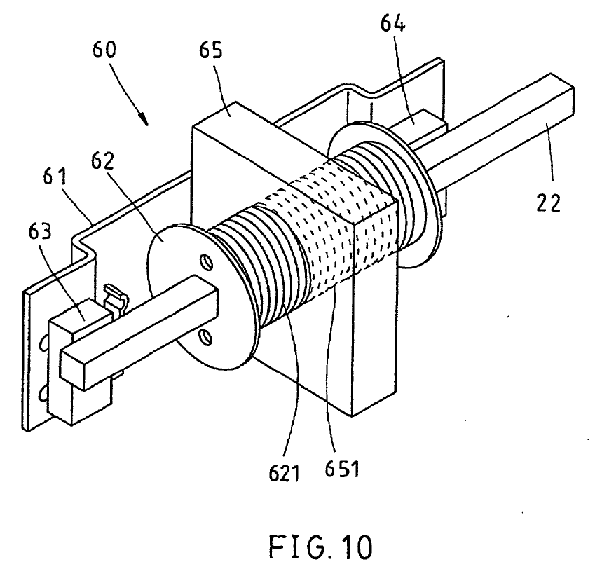

The operation of the present invention is understood with reference to FIGS. 5-9, when the user operates the signal transmitter 23 of the driving unit 20 to transmit a control signal of lifting the Venetian blind, the signal receiver 24 immediately receives the signal. Upon receipt of the signal, the signal receiver 24 drives the motor 21 to rotate the transmission shaft 22. Because the center through hole 314c of the cylindrical wheel body 314 of the spacing adjustment wheel 311 is a non-circular hole that fits the transmission shaft 22, rotating the transmission shaft 22 causes the spacing adjustment wheel 311 to be synchronously rotated to roll up the spacing cord 313, as shown in FIGS. 8 and 9. When rotating the spacing adjustment wheel 311 to roll up the spacing cord 313, the conical end portion 315b guide the spacing cord 313 to be smoothly wound around the bobbin 315. When the spacing adjustment wheel 311 rolls up the spacing cord 313, the bottom rail 123 is lifted, thereby causing the slats 121 to be received and moved with the bottom rail 123 upwards toward the headrail 11 to the desired elevation.

Because the spring 331 forces the angle adjustment wheel 321 against the stop flange 314a of the cylindrical wheel body 314 of the spacing adjustment wheel 311, a friction resistance is produced between the angle adjustment wheel 321 and the cylindrical wheel body 314 of the spacing adjustment wheel 311, thereby causing the angle adjustment wheel 321 to be synchronously rotated with the spacing adjustment wheel 311 during rotary motion of the spacing adjustment wheel 311. During rotary motion of the angle adjustment wheel 321, the angle cord 322 is moved, causing the slats 121 to be tilted. This tilting continues until the angle adjustment wheel 321 turns sufficiently for the protruding block 321a to contact one of the shoulders 312c. The contacted shoulder 312c provides to the protruding block 321a a reactive force which surpasses the friction resistance between the angle adjustment wheel 321 and the cylindrical wheel body 314 of the spacing adjustment wheel 311, as shown in FIGS. 5 and 6, stopping the angle adjustment wheel 321 from rotation with the spacing adjustment wheel 311. Therefore, when the angle adjustment wheel 321 is rotated to this angle, it is disengaged from the spacing adjustment wheel 311. At this time, the transmission shaft 22 continuously rotates the spacing adjustment wheel 311 to roll up the spacing cord 313 and to receive the slats 121 without changing the tilting angle of the slats 121.

When releasing the slats 121, one operates the signal transmitter 23 to transmit a control signal of releasing the slats to the signal receiver 24. Upon receipt of the signal, the signal receiver 24 immediately drives the motor 21 to rotate in the reversed direction, thereby causing the transmission shaft 22 and the spacing adjustment wheel 311 to be rotated in the same reversed direction. Reverse rotation of the spacing adjustment wheel 311 lets off the spacing cord 313, and therefore the bottom rail 123 and the slats 121 are lowered to extend out the Venetian blind 10. During rotary motion of the spacing adjustment wheel 311 to let off the spacing cord 313, the angle adjustment wheel 321 continues to be forced by the spring 331 against the cylindrical wheel body 314 of the spacing adjustment wheel 311, thereby causing the angle adjustment wheel 321 to be synchronously rotated with the spacing adjustment wheel 311 to tilt the slats 121. However, when the angle adjustment wheel 321 is reversed to such a position that the protruding block 321a touches the other shoulder 312c of the support 312 (see FIG. 7), the angle adjustment wheel 321 is stopped from rotation with the spacing adjustment wheel 311. At this time, the transmission shaft 22 continuously rotates the spacing adjustment wheel 311 to let off the spacing cord 313 and to release the slats 121 without changing the tilting angle of the slats 121.

With respect to the tilting of the slats 121, the operation is described hereinafter. At first, the user operates the signal transmitter 23 to transmit a slat tilting control signal to the signal receiver 24. Upon receipt of the control signal, the signal receiver 24 immediately drives the motor 21 to rotate the transmission shaft 22 and the spacing adjustment wheel 311, and to further cause the angle adjustment wheel 32 to be rotated synchronously to change the tilting angle of the slats 121. In actual practice, it is not necessary to tilt the slats 121 at a wide angle, therefore the angle of rotation of the angle adjustment wheel 311 can be limited within a limited range. According to the present preferred embodiment, the angle adjustment wheel 321 is rotatable with the spacing adjustment wheel 311 within about 180°. The shoulders 312c limit the angle of rotation of the angle adjustment wheel 321. When the slats 121 are tilted to the desired angle, the motor 21 is stopped. (During the above-described slat angle tilting control operation, the amount of upward or downward movement of the bottom rail 11 due to rotation of the spacing adjustment wheel 311 is insignificant, without affecting the reliability of the operation.)

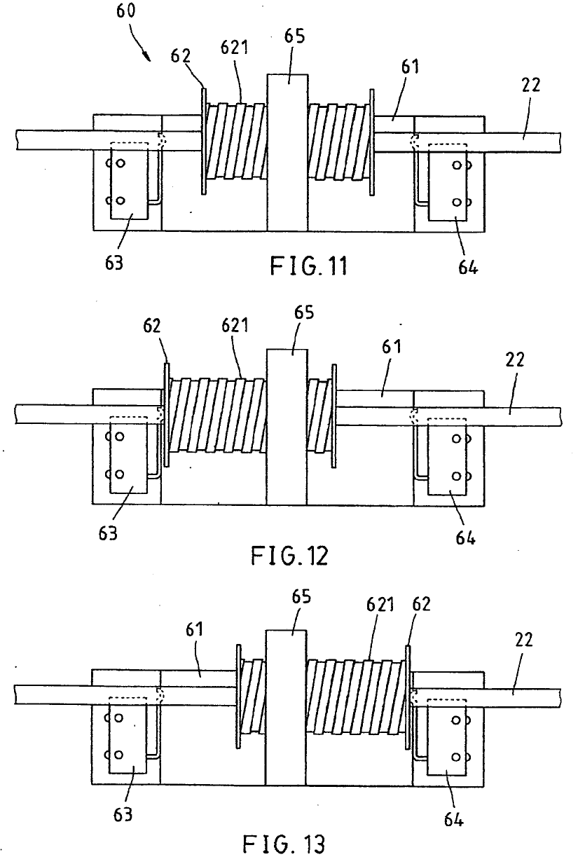

Referring to FIGS. 10-13, the friction transmission mechanism 100 further includes a detector 60 installed in the middle of the transmission shaft 22. When the slats 121 are moved to an upper limit or lower limit position, the detector 60 is operative to stop the motor 21. According to the present preferred embodiment, the detector 60 includes a mounting plate 61, a wheel 62, two limit switches 63 and 64, and a locating block 65. The mounting plate 61 is fixedly fastened to the peripheral wall of the holding chamber 111 of the headrail 11. The locating block 65 is fixedly mounted inside the holding chamber 111 of the headrail 11 having a center screw hole 651. The wheel 62 is coupled to the transmission shaft 22 for synchronous rotation, having an outer thread 621 threaded into the center screw hole 651 of the locating block 65. Rotation of the transmission shaft 22 causes synchronous rotation of the wheel 62 with the transmission shaft 22 and axial movement of the wheel 62 in the locating block 65. The limit switches 63 and 64 are respectively mounted on the mounting plate 61 at two sides relative to the wheel 62 (in such positions where the wheel 62 touches one limit switch 63 or 64 when the slats 121 are moved to the upper limit or lower limit position), and electrically connected to the motor 21. When the slats 121 moved to the upper or lower limit position, the wheel 62 touches one limit switch 63 or 64, thereby causing the limit switch 63 or 64 to cut off power from supplying the motor 21 in the direction activating the limit switch.

The present invention, as described above in connection with FIGS. 1-13, provides a number of advantages. For example:

1. Slat Lifting and Tilting Dual-Control Function:

The friction resistance between the angle adjustment wheel and the spacing adjustment wheel causes the angle adjustment wheel to be synchronously rotated with the spacing adjustment wheel, and the shoulders of the support and the protruding block of the angle adjustment wheel serve as clutch means to control synchronous rotation of the angle adjustment wheel with the spacing adjustment wheel, and therefore one single driving source is sufficient to control rotation of the spacing adjustment wheel, which controls lifting of the slats, and the angle adjustment wheel, which controls tilting of the slats.

2. Single Drive Source and Compact Size:

Because one single driving source is sufficient to drive the spacing adjustment wheel and the angle adjustment wheel, the invention is inexpensive to manufacture and, requires less installation space.

3. Durable Mechanical Design:

Because the friction transmission mechanism is provided with a detector, the motor is immediately stopped when the slats reach their upper or lower limit position, preventing damage to the parts of the mechanism. It will be understood that a torque-limiting device can be substituted for the detector 60, either in the form of a slip clutch, hydraulic coupling or the like connected between the motor 21 and the roll-up units 30, or in the form of a current limiting feature of the motor 21 for permitting stalled operation thereof without overheating, such devices being known to those having skill in the relevant arts.

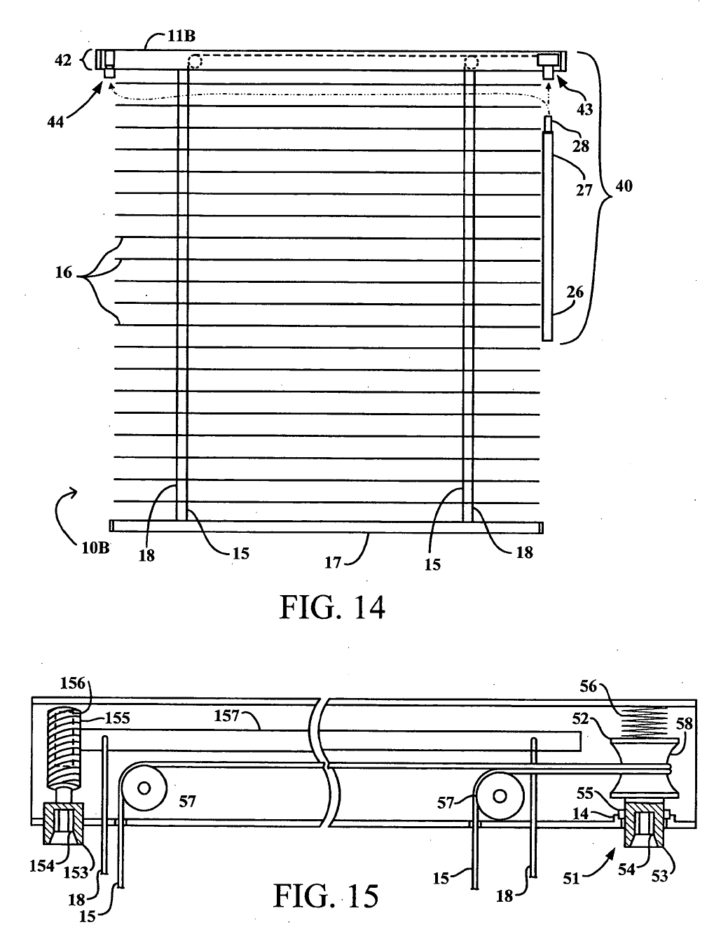

With further reference to FIGS. 14 and 15, an alternative configuration of the Venetian blind 10, designated 10B, incorporates a blind control system 40 having a linking mechanism 42 that combines a lifting mechanism 43 for lifting a blind body that includes a set of slats 16 and a bottom rail 17, and a tilting mechanism 44 for tilting the slats. The blind control system 40 also includes an operating device 46 having a coupling tip 28 and being further described below, for selective operation of the lifting and/or tilting mechanisms 43 and 44. The lifting mechanism 43 includes a driving force input unit 51, a spring member 56, and two pulleys 57. The driving force input unit 51 includes a bobbin 52 and a rod member 53 coaxially and fixedly fastened to the bottom side of the bobbin 52. The rod member 53 has a driving force receiving portion 54 in the bottom end thereof, and a toothed portion 55 around the periphery. The driving force input unit 51 is fastened pivotally with the inside of the right end of a headrail 11B of the Venetian blind 10B, with the rod member 53 projecting downwardly therethrough. The headrail 11B has a toothed portion 14 that is engagable by the toothed portion 55 of the rod member 53. A spring member 56 is connected between the top side of the bobbin 52 and the top sidewall of the headrail 11B to impart a downward pressure to the bobbin 52 and the rod member 53, keeping the toothed portion 55 of the rod member 53 meshed with the toothed portion 14, the rod member 53 being axially moveable upwardly against the spring 56 sufficiently to disengage the toothed portions 14 and 55 for permitting rotation of the rod member. The pulleys 57 are fastened pivotally with the inside the headrail 11B and symmetrically located on the left and right ends of the headrail 11B. The Venetian blind 10B includes two lift cords 15 symmetrically inserted through the slats 16, a bottom end being fixedly connected to the bottom rail 17, and a top end inserted upwardly into the inside of the headrail 11B and extended over the periphery of the corresponding pulley 57 and then fastened to the periphery of the bobbin 52 of the driving force input unit 51. When rotating the driving force input unit 51, the bobbin 52 is rotated to roll up or let off the lift cords 15, and therefore the bottom rail 17 is lifted or lowered, carrying the slats 16 to the desired elevation, i.e., the periphery of the bobbin 52 forms an output force driving unit 58.

The tilting mechanism 44, for controlling the tilting angle of the slats 16, includes a worm 155 and a worm gear 156 adapted to rotate a tilt rod 157, causing it to move two ladder tapes 18 and to further control the tilt angle of the slats of the Venetian blind 10B. The worm 155 is mounted on a rod member 153 having a driving force receiving portion 154 in the bottom end for receiving the coupling tip 28 of the operating device 46. In general, the linking mechanism 42 has two independent driving force input units (driving force receiving portions and two driving force output units so that the user can couple the operating device 46 to the driving force input units selectively, and operate the operating device 46 to lift the bottom rail 17 of the Venetian blind 10B to the desired elevation or, to adjust the tilting angle of the slats 16 of the blind body of the Venetian blind 10B by engagement of the coupling tip 28 with the driving force receiving portion of the tilting mechanism 44.

The operating device 46 is substantially a rod-like member that is preferably not directly connected to the linking mechanism 42. The user can hold one end of the operating device 46 with the hand in a vertical position, keeping the other end of the device at the elevation of the headrail 11B. The operating device 46 has an operating portion 26 at its one end for the holding of the hand, and an actuating portion 27 at its other end, terminating in the coupling tip 28. The coupling tip 28 is detachably connectable to either of the driving force receiving portions 54 and 154 of the linking mechanism 42. After connection of the coupling tip 28 to the selected receiving portion, the user can rotate the operating portion 26 with the hand, enabling the rotary driving force to be transmitted through the selected driving force receiving portion 54 or 154 of the linking mechanism 42. Thus the user can operate the operating device 46 to adjust the Venetian blind 10B.

When adjusting the height or spacing of the slats 16, the coupling tip 28 of the actuating portion 26 of the operating device 46 is forced into engagement with the driving force receiving portion 54 of the driving force input unit 51, and then the operating device 46 is pushed to move the rod member 53 and the bobbin 52 upwards against the spring member 56 and to disengage the toothed portion 55 from the toothed portion 14, and then operating device 46 is manipulated to rotate the driving force input unit 51, causing the bobbin 52 to roll up or let off the lift cords 15, and therefore the bottom rail 17, together with slats 16 resting thereon, is lifted or lowered to the desired elevation. After the blind body 12B has been adjusted to the desired elevation, the operating device 46 is disengaged from the driving force receiving portion 54, simultaneously enabling the driving force input unit 51 to be lowered such that the toothed portion 55 of the driving force input unit 51 meshes with the toothed portion 14 of the headrail 11B, and therefore the bobbin 52 is locked and, the blind body 12B is fixed in position.

Similarly, the operating device 46 may be coupled to the rod member 153 of the tilting mechanism 44 for adjusting the tilt angle of the slats 16, rotation of the coupling tip 28 being transmitted from the driving force receiving portion 154 to the worm 155 and transmitted by the worm gear 156 to the tilt rod 157 to operate the ladder tapes 18. The tilt angle remains set following withdrawal of the operating device 46 because of the self-locking action of the worm 155 in its engagement with the worm gear 156.

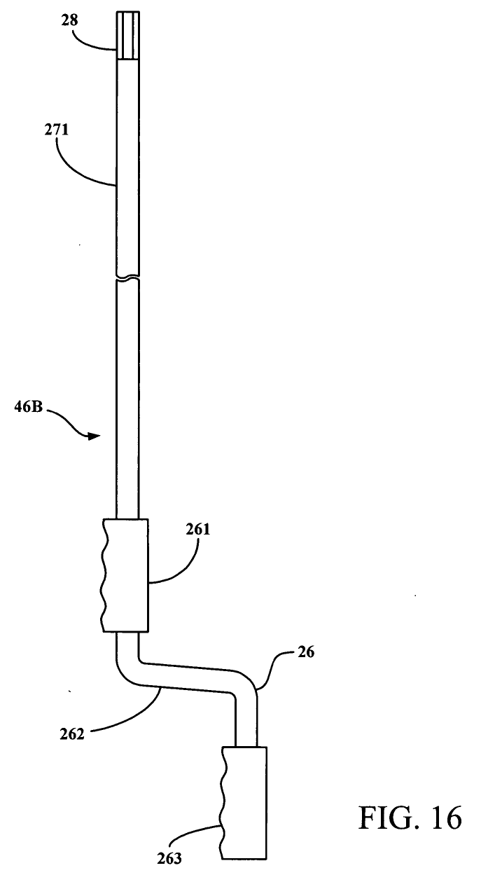

With further reference to FIG. 16, an alternative configuration of the operating device, designated 46B, includes a first handgrip 261, an elongated counterpart of the actuating portion, designated 271 fastened pivotally with the front end of the first handgrip 261 and terminating in the coupling tip 28 having a hexagonal shape and which can be inserted into the selected driving force receiving portion 54 or 154, each having a corresponding hexagonal shape and a tapered outer hole for facilitating engagement by the coupling tip 28. The operating device 46B also includes a crank 262 fastened pivotally with the first handgrip 261 and coupled to the elongated actuating portion 271, and a second handgrip 263 fixedly fastened to one end of the crank 262 in offset relation to the first handgrip 261. The crank 262 and the second handgrip 263 form the operating portion 26.of the operating device 46B. When in use, the user can hold the first handgrip 261 with one hand and rotate the second handgrip 263 with the other hand. When rotating the second handgrip 263, the elongated actuating portion 271 is rotated with the crank 262 and the second handgrip 263 relative to the first handgrip 261.

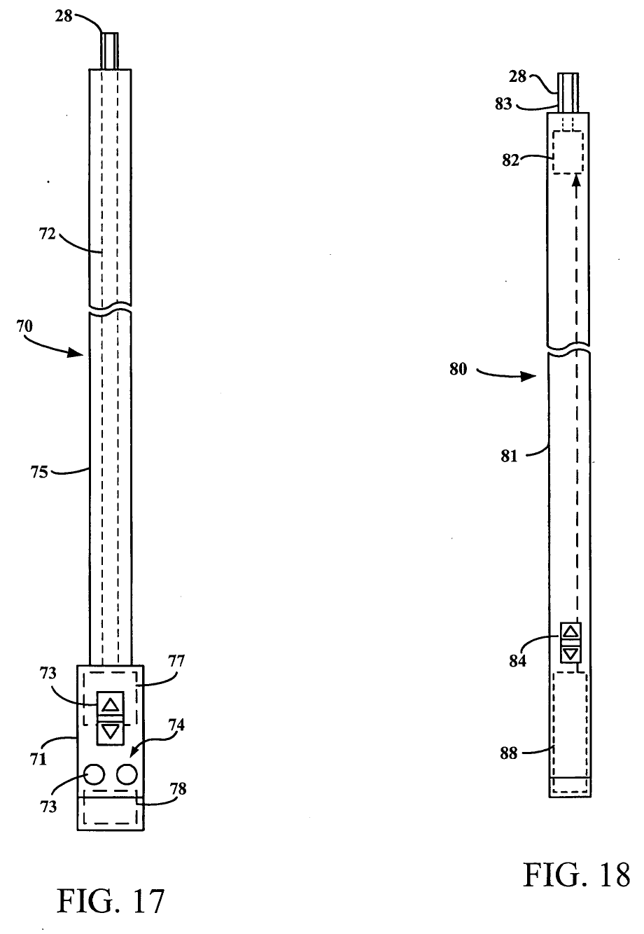

With further reference to FIG. 17, an alternative configuration of the operating device, designated 70, is an electrically controlled device including a casing 71, a rod-like actuating portion 72 forwardly extended out of the front side of the casing 71, a motor 77 mounted inside the casing 71 and adapted to rotate the rod-like actuating portion 72, a battery power supply 78 mounted inside the casing 71 and electrically connected to the motor 77, a control panel 74 located on the outside wall of the casing 71 and including of a set of control buttons 73 adapted to control on/off status and forward/backward rotation of the motor, and a protective sleeve 75 fixedly fastened to the front side of the casing 71 around the rod-like actuating portion 72. The rod-like actuating portion 72 has a front end extended out of the front end of the protective sleeve 75 and terminating in the coupling tip 28. The operating device 70 also includes suitable electrical connections between the control buttons 73, the battery 78, and the motor 77 for operation thereof, such being within the ordinary skill of the art.

With further reference to FIG. 18, an alternative configuration of the electrically controlled operating device, designated 80, includes a tubular main body 81, a motor 82 mounted in the front end of the tubular main body 81, a rod-like actuating portion 83 rotationally coupled to the motor 82 and extended out of the tubular main body 81 to form the coupling tip 28. The operating device 80 also includes control buttons 84 located on the tubular main body 81 near its rear end remote from the motor 82 and the rod-like actuating portion 83, the buttons 84 being electrically connected to the motor 82 and to a battery 88 that is located within the main body 81 for operation of the motor 82.

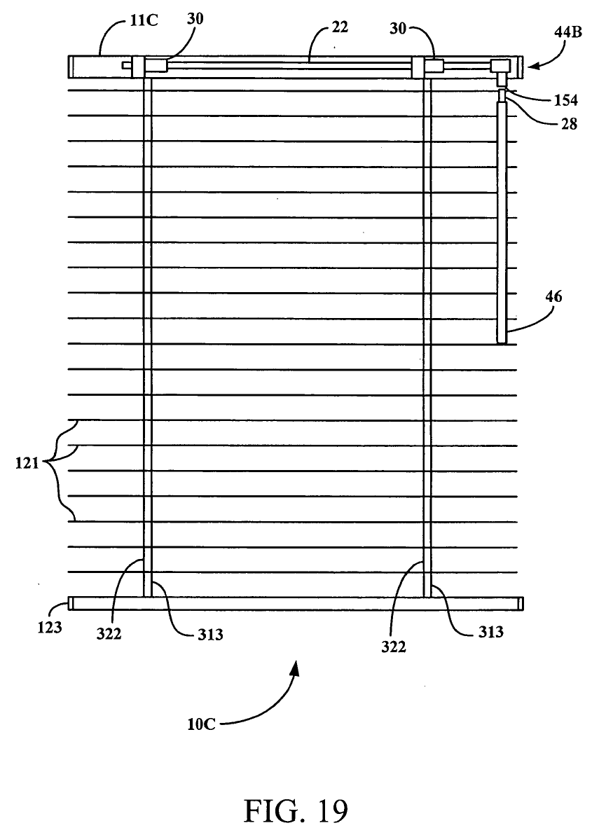

With further reference to FIG. 19, the present invention provides a Venetian blind, designated 10C, that combines features of the mechanism 100 of FIGS. 1-13 with features of the control system 40 of FIGS. 14-18, wherein one single operating device is effective to simultaneously control the lifting of the blind body and tilting of the slats of any of several Venetian blinds. More particularly, the blind 10C has a counterpart of the tilting mechanism, designated drive unit 44B, with a counterpart of the transmission shaft 22 substituted for the tilt rod 157 and driving a pair of the cord roll-up units 30 as described above. Thus the operating device 46, when coupled with the coupling tip 28 engaging the force receiving portion 154, is effective for adjusting the height as well as the tilt of the slats 16. It will be understood that the operating device 46 can be permanently connected to the drive unit 44B as an alternative to being removably connectable thereto.

Basically, the linking mechanisms of conventional blinds commonly use (or can use) a rotary action to achieve blind body lifting/lowering or extending/receiving control and slats tilting control. Therefore, the lifting and tilting devices of the present invention can be used in any of a variety of blinds.

As indicated above, the invention has the advantages as follows:
1. Because the invention does not use any lift cord or like means to achieve blind body lifting control, it eliminates the possibility of the hanging of the head of a person (more particularly a child) on the lift cord accidentally.
2. Because the blind control system of the present invention (in the preferred configurations described above) has no control member exposed to the outside of the blind, the sense of beauty of the blind is maintained intact.
3. Because conventional electric blinds have an independent motor, power adapter, control circuit, and etc., their manufacturing cost is high. The invention as described above in connection with FIGS. 14-19 can use one electrically controlled operating device to control the mechanical linking mechanism of each of a number of blinds. Therefore, the invention greatly reduces the installation cost of multiple blinds in one house.
4. Conventional battery-powered electric blinds have the battery installed in the headrail. When replacing the battery, the user needs to use a chair or ladder so as to access to the battery in the headrail. This battery replacing job is inconvenient to achieve. According to the present invention as described above in connection with FIGS. 17 and 18, the battery is installed in the operating device, which is separated from the blind. Therefore, the user can replace the battery of the operating device conveniently.
5. Because the invention does not use the spring power of a spring member or the tension of a cord member to hold the blind body at the desired elevation, the invention can control and maintain the position status of the blind body stably.

Although particular embodiments of the invention have been described in detail for purposes of illustration, various modifications and enhancements may be made without departing from the spirit and scope of the invention. Accordingly, the spirit and scope of the appended claims should not be limited to the description of exemplary and/or preferred versions contained herein.

What is claimed is:

1. A Venetian blind comprising a headrail, a bottom rail, a set of slats supported between the headrail and the bottom rail, and a blind control system, the control system comprising:
(a) a spacing adjustment set comprising a support, a spacing cord connected to the bottom rail and adapted to decrease or increase a spacing between pairs of the slats, and a spacing adjustment wheel rotatably engaged to the support to roll up or let off the spacing cord;
(b) an angle adjustment set comprising an angle cord adapted to tilt the slats, an angle adjustment member rotatably supported relative to the support and adapted to roll up or let off the angle cord; and
(c) a drive mechanism for selectively driving the spacing adjustment wheel and the angle adjustment member to adjust both the spacing of the spacing adjustment set or the tilt of the angle adjustment set, wherein the drive mechanism comprises:
i. a transmission shaft coupled to the spacing adjustment wheel, the transmission shaft comprising:
1. a driving force input member;
ii. an operating device coupled to the transmission shaft, the operating device comprising:
1. an operating portion at one end thereof; and
2. an actuating portion at an opposite end thereof for selectively rotating the driving force input member, the actuating portion having a coupling tip removably connectable to the driving force input member for rotating the transmission shaft;
iii. a friction coupling between the spacing adjustment wheel and the angle adjustment member; and
iv. a stop device coupled between the angle adjustment member and the support to limit rotation of the angle adjustment member to a predetermined angle, whereby the angle adjustment member is rotated by the spacing adjustment wheel as limited by the stop device upon rotary motion of the spacing adjustment wheel;
wherein the operating device comprises a hand crank.

2. The Venetian blind as claimed in claim 1, wherein the stop device comprises a shoulder projecting at one side of the support, and a protruding block projecting from the angle adjustment member and adapted to act against the shoulder of the support.

3. The Venetian blind as claimed in claim 1, wherein the friction coupling comprises spring means mounted in between the support and the angle adjustment member and forcing the angle adjustment member against the spacing adjustment wheel to produce frictional contact therebetween.

4. The Venetian blind as claimed in claim 3, wherein the spring means is a coiled spring.

5. The Venetian blind as claimed in claim 1, wherein the spacing adjustment wheel comprises a conical end portion disposed in the periphery thereof at one end and adapted to guide winding of the spacing cord round the spacing adjustment wheel.

6. The Venetian blind as claimed in claim 1, wherein the drive mechanism further comprises a worm and worm gear meshed therewith coupled between the operating device and the transmission shaft.

7. A Venetian blind comprising a headrail, a bottom rail, a set of slats supported between the headrail and the bottom rail, and a blind control system, the control system comprising:
(a) a spacing adjustment set comprising a support, a spacing cord connected to the bottom rail and adapted to decrease or increase a spacing between pairs of the slats, and a spacing adjustment wheel rotatably engaged to the support to roll up or let off the spacing cord;
(b) an angle adjustment set comprising an angle cord adapted to tilt the slats, an angle adjustment member rotatably supported relative to the support and adapted to roll up or let off the angle cord; and
(c) a drive mechanism for selectively driving the spacing adjustment wheel and the angle adjustment member to adjust both the spacing of the spacing adjustment set or the tilt of the angle adjustment set, wherein the drive mechanism comprises:
i. a reversible motor;
ii. a transmission shaft coupled between the reversible motor and the spacing adjustment wheel and driven by the reversible motor to rotate the spacing adjustment wheel; and
iii. a control circuit for operating the reversible motor in response to operator input;
wherein the motor is mounted in an operating device, the operating device being removably connectable for driving the transmission shaft.

8. The Venetian blind as claimed in claim 7, further comprising a worm and worm gear meshed therewith coupled between the motor and the transmission shaft.

9. A Venetian blind comprising a headrail, a bottom rail, a set of slats supported between the headrail and the bottom rail, and a blind control system, the control system comprising:
(a) a spacing adjustment set comprising a support, a spacing cord connected to the bottom rail and adapted to decrease or increase a spacing between pairs of the slats, and a spacing adjustment wheel rotatably engaged to the support to roll up or let off the spacing cord;
(b) an angle adjustment set comprising an angle cord adapted to tilt the slats, an angle adjustment member rotatably supported relative to the support and adapted to roll up or let off the angle cord; and
(c) a drive mechanism for selectively driving the spacing adjustment wheel and the angle adjustment member to adjust both the spacing of the spacing adjustment set or the tilt of the angle adjustment set, wherein the drive mechanism comprises:
i. a linking mechanism mounted in the headrail, the linking mechanism comprising:
1. a first driving force input unit rotatable by an external rotary driving force, the first driving force input unit having a driving force receiving portion adapted to receive an external rotary driving force, and a first driving force output unit coupled to the spacing adjustment wheel;
2. a second driving force input unit rotatable by the external rotary driving force, the second driving force input unit having a driving force receiving portion adapted to receive the external rotary driving force, and a second driving force output unit coupled to the angle adjustment member; and
3. an operating device selectively connectable to the first and second driving force input units for operation to rotate the driving force input units.

10. The Venetian blind as claimed in claim 9, wherein the operating device has an operating portion at one end thereof for operation by hand and an actuating portion at an opposite end thereof for selectively rotating the first and second driving force input units, the actuating portion having a coupling tip connectable to the driving force receiving portion of the selected driving force input unit.

11. The Venetian blind as claimed in claim 10, wherein the operating device comprises a hand crank.

12. The Venetian blind as claimed in claim 9, wherein the operating device comprises a casing having an operating portion at one end thereof, an actuating portion at an opposite end thereof for selectively rotating the first and second driving force input units, the actuating portion having a coupling tip connectable to the driving force receiving portion of the selected driving force input unit, a motor mounted within the casing and coupled to the coupling tip for rotation thereof, means for receiving a battery in the casing, and manually operable controls for selectively powering the motor from a battery.
